(19) United States
(12) Patent Application Publication
(10) Pub. No.: US 2012/0005129 A1
(43) Pub. Date: Jan. 5, 2012

(54) Food Container Sale Method

(75) Inventors: Lisa Phillips, Pleasanton, CA (US); Mary Jo Cook, Pleasanton, CA (US); Marcus Wang, Pleasanton, CA (US)

(73) Assignee: The Glad Products Company, Oakland, CA (US)

(21) Appl. No.: 13/178,850

(22) Filed: Jul. 8, 2011

Related U.S. Application Data
(63) Continuation-in-part of application No. 12/509,846, filed on Jul. 27, 2009.

(51) Int. Cl. G06Q 90/00

(52) U.S. Cl. 705/500

(57) ABSTRACT

A method for selling individual containers used for the storage of fresh foods comprising the steps of providing individual containers in store and adjacent a fresh food product to be purchased, and charging the shopper for the container on a per container basis separately from the food purchased. The bags or containers used in the method of the invention will include at least one feature or characteristic that adds value for the consumer over and above the bags currently provided for free by grocery stores in the produce section.

### CROSS-REFERENCE TO RELATED APPLICATIONS

This application is a continuation in part of U.S. patent application Ser. No. 12/509,846, filed Jul. 27, 2009.

### BACKGROUND OF THE INVENTION

1. Field of the Invention

The present invention relates to an in-store method for providing individual containers to a consumer, where the containers are characterized by having at least one product storage enhancing characteristic and permitting the consumer to choose the empty, individual container sold by unit, fill the container with individual bulk produce or other items sold by weight, and pay for the combined container and bulk items at the check-out counter both by container unit and bulk item weight.

2. Description of the Related Art

There are many known materials and methods related to the purchase and storage of bulk fresh food items, such as fruits, cheeses, meat, fish, vegetables, coffee beans and the like in a grocery store or “farmer's market” setting. Most commonly, a shopper is given a container, such as a plastic or paper bag or wrap, into which the shopper or shop keeper places the desired amount of bulk product for purchase. Most often, the container and product are then carried to the point of purchase where the combined bag and product are weighed and the consumer is charged for the combination based on the per weight cost of the product. In some settings, the store will permit, or require, that the store staff or shopper weigh and label the food items in the department in which they are displayed in order to speed the purchase of the item at the checkout counter and to avoid the consumer having to pay for the weight of the container with his or her purchase. This process can include the placement by the store staff of a universal product code or so-called “bar” code on the outside of the container so that the container and product can be scanned together at a checkout counter.

In order to minimize the cost to the store owner of providing these plastic or paper containers to the consumer in the store, the materials that are provided, for example plastic bags, are made of very inexpensive material; a material that has little value in terms of protecting and storing the product. These materials provide the benefit of permitting the shopper to carry the food item (say, for example, a few apples) to the front counter for purchase. The material from which the bag is made is also extremely light, making the cost of the bag as charged to the consumer by weight, de minimis. On the other hand, the plastic bag provides no protection or storage benefit when taken home. That is, the item that has been carried from the store in the plastic bag must typically be removed from the plastic bag (or other freely supplied container) in order to avoid faster spoilage caused by the characteristics of the bag. Further, the use of these bags or other containers is wasteful, since they are most often not sturdy enough to be reused.

Published U.S. patent application 2006/0171606 A1 describes a bag having characteristics that provide the benefit of permitting quick inspection of the contents, for example at airport security or other security checkpoints where such bags and their contents need to be inspected. This application also describes a business method in which such bags are made available for sale to a consumer/user near their point of use, generating revenue for the seller.

Many fresh food items, such as produce, fruit, vegetables, cheeses and meat, are sold both in prepackaged amounts and in bulk. The availability of these fresh food items in bulk allows the consumer to choose both the right amount and the desired quality of these fresh food items. This may not be possible with prepackaged fresh food items. However, the consumer currently lacks the ability to get this choice and also optimally package this choice directly and easily in the supermarket.

There are many disclosures of plastic bags and other containers that are suitable for the packaging and storage of fresh food items, such as fresh fruits and vegetables, and that are made of materials (or are configured in a particular way) so as to permit the food item to remain unspoiled for an extended period of time. That is, these containers are designed to prolong the time before the product becomes spoiled relative to storage without a container (e.g. simply placed in a refrigerator) or in the thin film plastic bags given away in the grocery store. Such containers are sometimes available to customers of the same store in which fresh food products are sold, however, they are not sold individually and are not typically positioned in the same area of the store as the fresh food. There is also no mechanism for the customer to combine the container with their desired amount of bulk product items prior to check-out. The consumer must either try to find a suitable pre-packaged amount of product items or must buy separately a plurality of specialized containers and bulk product items in ordinary containers, and then remember to repackage the bulk product items in the specialized containers at home, potentially resulting in increased spoilage. Thus, for example, customers who are purchasing fruits or vegetables will typically use the free plastic bags in the produce section, take them home, remove the produce from the free bag and place it in a separate storage container that will permit the produce to remain fresh for a longer period of time. Or, the customer will take the produce home in the provided plastic bag and store it in that bag, resulting in relatively fast spoilage of the produce.

### SUMMARY OF THE INVENTION

The present invention comprises a method for individually selling a container, such as a recloseable and/or resealable plastic bag or other container, the container having at least one characteristic for improving the storage time or quality of a fresh food item stored in the container. In one form, the method is accomplished by making a storage container according to the invention individually available in the section of a store selling the bulk food item, permitting the customer access to the individual container (and permitting the customer to place the food item in the container), and charging the customer separately from the amount of bulk food item by weight for the container on a per container basis (i.e. typically not by weight), for example when the customer reaches the checkout stand of the store. The method provides the customer with a number of advantages: being able to directly place the desired food item in the container at the store, being able to purchase the container separately and not in packages of multiple containers having disposable secondary packaging, and to avoid having to replace the food item in a different storage container when the purchase is brought home. These advantages, coupled with the in-store use of a container that keeps the food fresher longer, provides significant added value to the purchaser/consumer. Overall, for the purchaser, this also results in less handling of the food item, avoiding possible contamination and/or bruising, and an increased chance that the food item will be stored properly when taken home. For the seller, a new revenue stream is created as consumers will better appreciate the value of using a container according to the invention which is made individually available to them close to the time and place in the store where the consumer decides to purchase the fresh food. The consumers may also be persuaded to purchase easily spoiled items, since the consumer is immediately presented with an option to decrease the spoilage of those items.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. It should be noted that the figures are not drawn to scale, and that elements of similar structure or function are generally represented by like reference numerals for illustrative purposes throughout the figures. Understanding that these drawings depict only typical embodiments of the invention and are not therefore to be considered to be limiting of its scope, the invention will be described and explained with additional specificity and detail through the use of the accompanying drawings in which:

FIG. 1 illustrates a display unit in accordance with an embodiment of the invention;

FIG. 2 illustrates a display unit in accordance with an embodiment of the invention;

FIG. 3 illustrates a display unit in accordance with an embodiment of the invention;

FIG. 4 illustrates a display unit in accordance with an embodiment of the invention;

FIG. 5 illustrates a display unit in accordance with an embodiment of the invention; and

FIG. 6 illustrates a bag of the invention.

### DETAILED DESCRIPTION

The invention is a method for selling an individual storage container, the method comprising the steps of providing to a store customer a fresh food item sold in bulk, the fresh food item selected from the group consisting of fruit, vegetables, and combinations thereof; providing to a store customer an empty, individual storage container from a packet of empty, individual storage containers to a store customer, the packet not being suitable for sale and the individual storage container being suitable for sale, the individual storage container including a characteristic that permits food stored in the container to remain fresh longer than if the food item is not stored in the container, the individual storage container having both a description of a suitable fresh food item and a universal product code marking; permitting the customer to place the desired amount of bulk food item inside the empty, individual storage container to obtain a desired amount of bulk food item packaged for freshness; and permitting the customer to purchase in one transaction the combination of the desired amount of bulk food item and the individual storage container, the individual container purchased on a per unit basis and the bulk food item purchase on a per weight basis, the transaction not requiring the removal of the bulk food item from the individual storage container.

In another embodiment, the invention is a method for selling an individual storage container, the method comprising the steps of providing to a store customer a fresh food item sold in bulk, the fresh food item selected from the group consisting of fruit, vegetables, and combinations thereof, the fresh food item having a first universal product code marking; providing to a store customer an empty, individual storage container from a packet of empty, individual storage containers to a store customer, the packet not being suitable for sale and the individual storage container being suitable for sale, the individual storage container including a characteristic that permits food stored in the container to remain fresh longer than if the food item is not stored in the container, the individual storage container having both a description of suitable fresh food items and a second universal product code marking; permitting the customer to place the desired amount of bulk food item inside the empty, individual storage container to obtain a desired amount of bulk food item packaged for freshness; and permitting the customer to purchase in one transaction the combination of the desired amount of bulk food item and the individual storage container, the individual container purchased on a per unit basis and the bulk food item purchase on a per weight basis, the transaction allowing reading of both the first universal product code marking and the second universal product code marking, the transaction not requiring the removal of the bulk food item from the individual storage container.

In one form of the invention the method comprises providing a shopper in a grocery and/or produce store access to individual storage containers or bags. The containers can be made available in any of many known ways, for example if the containers are flexible bags, then from a roll of such bags positioned adjacent a display of produce. Storage bags and containers according to the method of the invention are known in the art but have not heretofore been made available for individual use and separate purchase in the store. For example, the bags can be sealable and/or resealable plastic bags such as are sold under brands such as GLAD® or others. According to the invention, however, these bags will be provided for separate and individual purchase rather than in a box or other package of, say, ten, twenty or fifty or more bags. The individual bags are suitable for individual sale, for example by providing a universal product code marking on the individual bag. Since the bags are sold individually and suitable for individual sale, it would not be required that the packet, package, or carton of multiple bags have a universal product code marking, entered into the store sales system, or otherwise be suitable for individual sale. Most advantageously, the bags (or other containers) used in the method of the invention will include at least one feature or characteristic that adds value for the consumer over and above the bags currently provided for free by grocery stores in the produce section. A feature of such bags will be one that provides an extended time of freshness during storage over and above the time that is provided by the plastic bags of the prior art that are commonly provided by the store and not separately charged for. The bags will also be configured such that they are suitable for individual sale, for example, by having a universal product code marking The bags may also have an indication of their cost on each individual bag and a picture or description of suitable fresh food items, for example, beans.

Typical food bags available to consumers at the point of selection of fresh produce are of ordinary polyethylene film and provide no additional benefit for keeping food fresh. In fact, typical food bags may actually speed the spoilage of fresh produce compared to leaving the produce out in the air, because these bags can trap moisture and prevent fresh oxygen from entering the produce environment. Bags that provide extended freshness can include structural features that provide this benefit (e.g. engineered perforations or breathable films), and/or they may include chemical components that enhance or extend storage time. By “extended freshness” we mean the period of time over which the food item remains fresh in the sense of appearance, taste and/or smell. Where a chemical component is used to provide a benefit, the component may be integrated into the material from which the bag is formed, or it may be included in a component that is added to or inserted in the bag. Such component can be, for example, an insert in the bag which, in addition to including such chemical component, may also absorb moisture and/or provide a cushioning or protective benefit for the produce or other food product stored in the bag.

The characteristic that can be incorporated into the bag or other container used in the method of the invention can relate to the solution of any problem presented when fresh food is placed in the container. For example, the characteristic could be odor reduction for foods that may produce odors (e.g. onions, broccoli, cheeses or meat from a deli counter). Other characteristics that could be incorporated into the containers used in the invention could include desiccants, liquid absorbents, ethylene scavengers and oxygen scavengers. One known example of the type of engineered material that can be incorporated into containers according to the invention is disclosed in U.S. Pat. No. 5,891,376 (which is incorporated herein by reference in its entirety), which describes controlled gas permeability film materials that have the advantage of permitting longer term storage of vegetables and other foods.

It is also known in the prior art that carbon dioxide and oxygen atmospheres surrounding produce can be modified by utilizing the innate respiration behavior of the produce where oxygen is converted to carbon dioxide. With modified atmosphere (MA) packaging, produce is stored in polymeric film where the film permeability is exactly matched to the expected respiration behavior as influenced by temperature and atmosphere changes to provide the optimum carbon dioxide and oxygen atmosphere. The accumulated carbon dioxide and oxygen concentration in such a package will be related to the rate at which carbon dioxide and oxygen is consumed or generated by the produce and the container permeability by a simple mass balance. Controlled atmosphere research into broccoli, for example, has shown that oxygen levels below approximately 1% and carbon dioxide levels higher than approximately 15% independently induce offensive off-odors and off-flavors. Reported optimum oxygen and carbon dioxide concentrations for broccoli range from approximately 1 to 2.5% and approximately 5 to 10% respectively. Controlled atmosphere packaging achieves extended produce life because of effects such as slowing respiration and inhibiting pathogen growth.

The bag film material may be a controlled permeability film of any suitable type. The porosity of the film may be controlled by incorporation of an inert filler. The film forming polymer may be selected from polyolefins including polyethylene and polypropylene, polyesters including polyethylene terephthalate and polybutylene terephthalate, vinyl polymers including polyvinyl chloride, polyvinyl acetate, ethylene-vinyl acetate copolymers and ethylene-vinyl alcohol copolymers, polycarbonates and polystyrenes polyalkylene oxide polymers, including polyethylene oxide polymer; and blends of any of the above. Preferably the film forming polymer is a polyolefin more preferably polyethylene. A low density polyethylene is particularly preferred.

The inert filler may be of any suitable type. The inert filler may be an organic or inorganic filler. The inert filler may be a naturally-occuring porous material or synthetic porous material. The naturally occuring porous materials may be selected from inorganic materials, such as, pumice, tuff, rhyolite, dacite, reticulite, scoria, lapilli, agglomerate, perlite, pumicite, other volcanic rocks, natural zeolites or sandstones and organic materials, such as coal, char, charcoal, starch, seaweed, polymeric carbohydrates. The synthetic materials may be selected from porous glasses such as “Vycor”, clays modified to produce porosity, silicate phases, such as, cordierite or mullite or metal oxides, such as alumina, silica, zirconia or magnesia, or cerium compounds, or hydrophilic organic polymers, such as polyvinyl alcohol or polyacrylamide. Synthetic metallic compounds such as alumina, aluminum isopropoxide may be used.

Pumice particles having a particle size greater than the intrinsic film thickness of the film forming polymer has been found to be particularly suitable. The film forming polymer may be present in amounts of from approximately 50 to 99.995%, preferably 85 to 99.95% by weight based on the total weight of the controlled permeability film. More preferably the film forming polymer is present in amounts of approximately 90 to 99. 5% by weight based on the total weight of the controlled permeability film. The inert porous filler may be present in amounts of from approximately 0.005 to 50%, preferably 0.05 to 15%, more preferably approximately 0.5 to 10% by weight based on the total weight of the controlled permeability film. The inert porous filler may be dispersed throughout the polymeric film.

The plastic film in the bag may be biodegradable or compostable. An example of film technology for this use is disclosed in U.S. Pat. No. 6,984,426. In the process of buying the produce in a biodegradable bag, the consumer can then put any discarded produce back in the bag after use and throw the bag in an appropriate waste container.

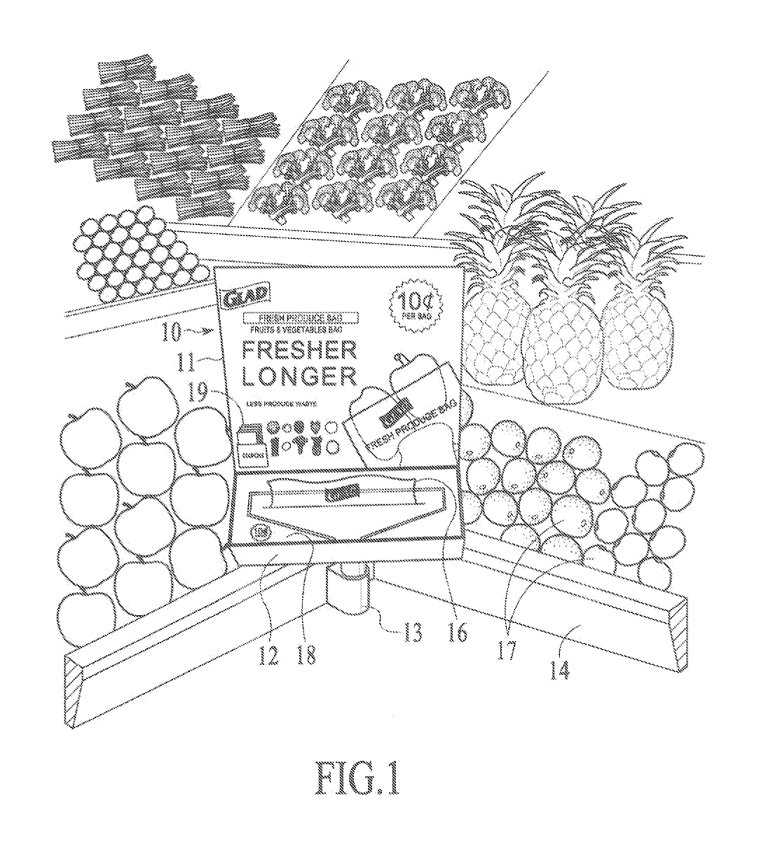

FIG. 1 illustrates a display unit 10 for single bag sales in accordance with an embodiment of the invention. As shown, the display unit 10 includes a display board 11, a carrier container 12 attached to the display board 11, and a support structure 13 for supporting the display board 11. The support structure 13 may be a coupling member for affixation to a produce counter 14. The display board 11 provides both a visual surface 15 providing visual information about the use of the bags 16 and produce 17, and the carrier container 12 removably holding a dispenser 18 for individual food bags 16. The visual surface 15 may include a product display showing the produce or other product for use with the bag, a representation of the bags or the bags in suitable secondary packaging such as a carton, and may include advertising information such as price or benefits, such as food freshness, or other items of visual interest. The visual surface 15 may also contain coupons 19 or other advertising for the food bags 16, or other products, such as produce or container products.

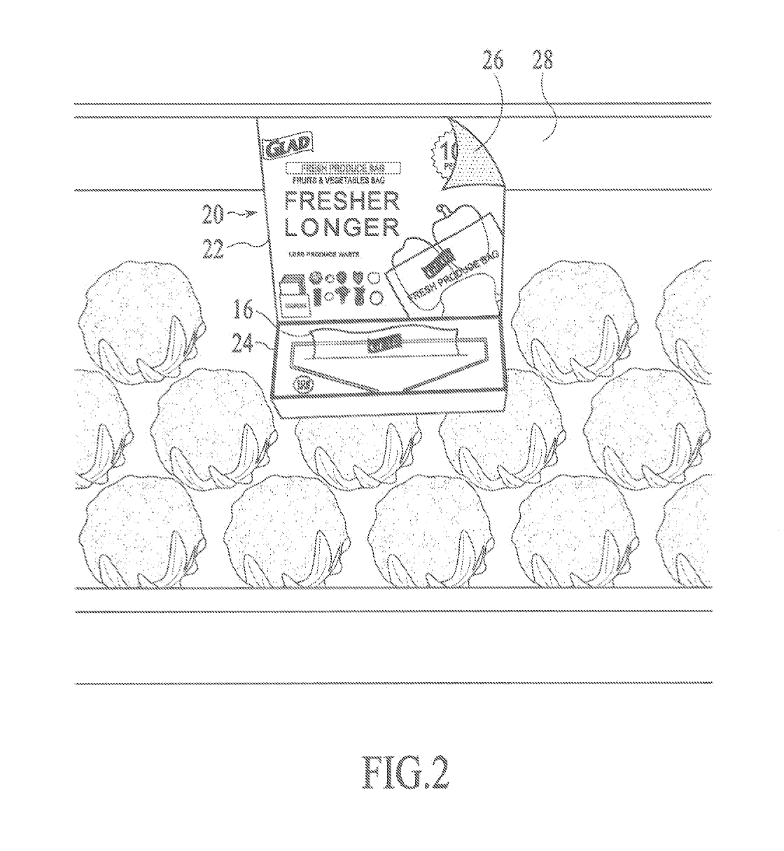

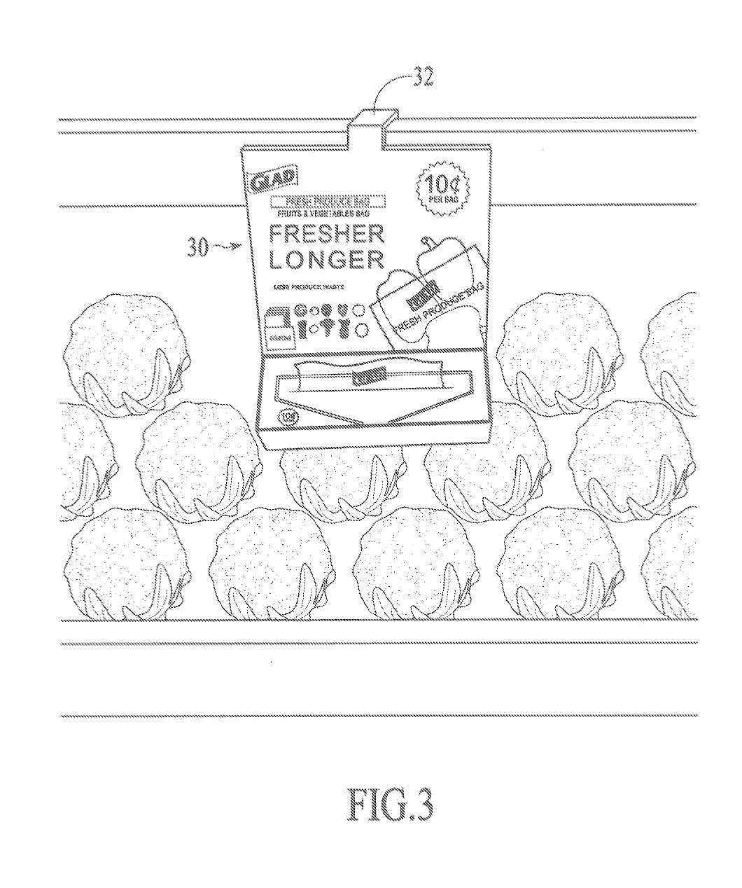

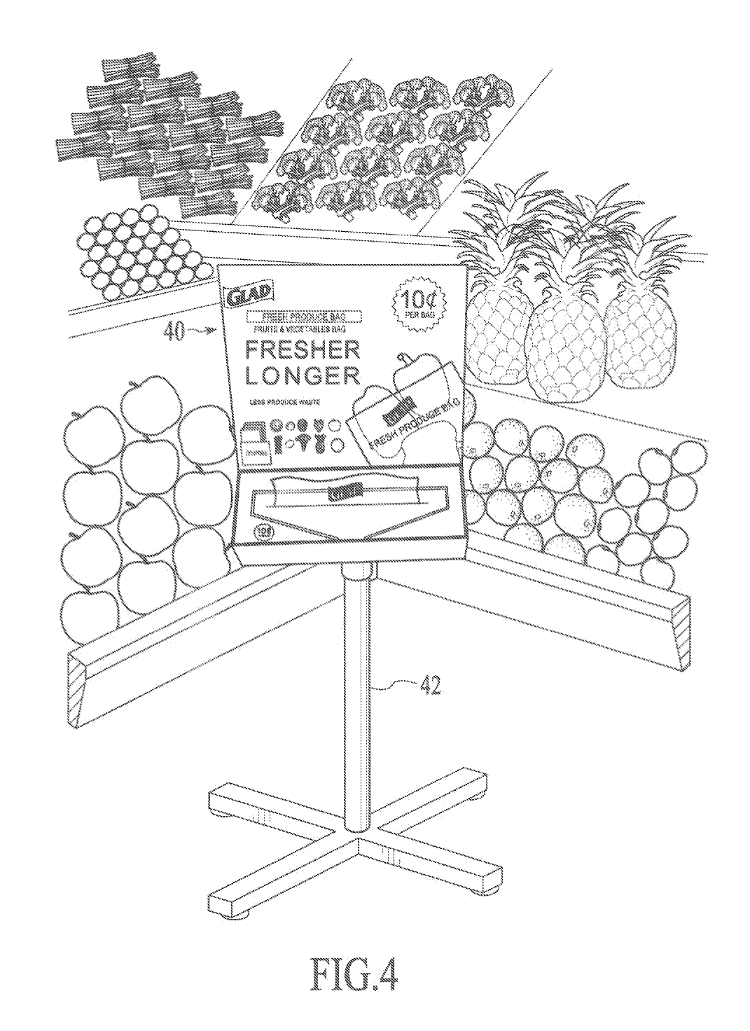

Alternatively, as in FIG. 2, the display unit 20 may have a display flap 22 attached to a dispenser 24 containing single purchase bags 16, where the display unit 20 has a coupling member 26 comprising may an adhesive member provided on a rear surface of the display unit 20 for attachment to a produce counter or other shelving unit 28. In FIG. 3, the display unit 30 may include a clip 32 for coupling to a shelf of a store. Thus, the display unit may easily be provided near the produce or other product being sold. In FIG. 4, the display unit 40 can have an independent support structure or stand 42 reaching to the floor. In FIG. 5, a roll 50 of single purchase food freshness bags 16 fits under the produce counter 52. The bags 16 may include a zipper closure 54, or alternately a slider closure (not shown). The bags 16 are attached to one another on the roll 50 by a line of perforation 56.

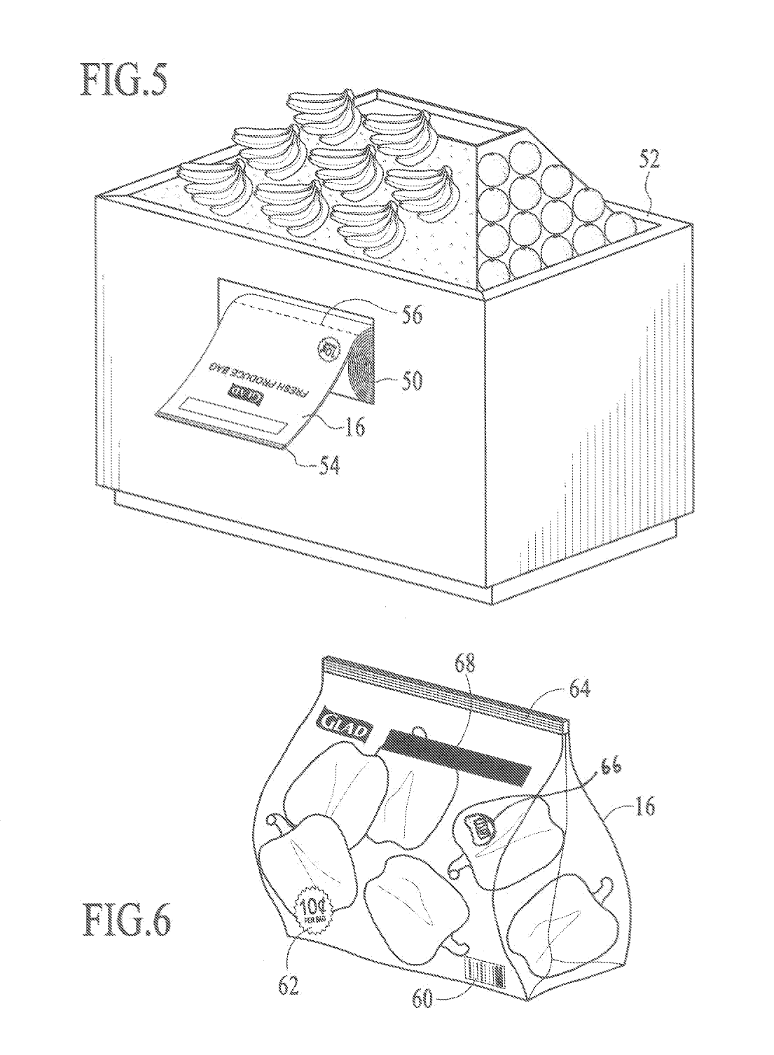

FIG. 6 shows a single transparent produce bag 16 filled with produce. The bag 16 has a universal product code 60 and a price label 62 including the product cost per bag. The bag 16 has an integral closure, a zipper closure 64. The bag additionally has a write on strip 68 for characterizing the produce or date. Inside the bag are individual items of produce also having a universal product code 66. When the customer decides to purchase a single transparent produce bag 16 and fills it with the desired amount and quality of fresh food items having a universal product code 66, the customer can proceed to checkout and purchase in one transaction the combination of the desired amount and quality of fresh food items and the single transparent produce bag 16. The store clerk can merely scan both the fresh food item universal product code 66 and the bag universal product code 60. The customer or store clerk is not required to open the bag 16 or to remove the fresh food item from the bag 16, before completing the transaction.

Access to bags according to the invention can be simple (bags placed nearby a fresh food display) or the bags or other containers could be made available from a dispensing machine. If a machine is used, the store would have the opportunity to charge for the container at the time of dispensing. Additionally, the store could use space on a dispensing machine to describe the benefits of using the containers for storage, and permit the user to purchase containers individually by depositing a coin in the machine, or by using any electronic means, such as the swipe of a credit or debit card, using an input code provided by the store for the purchasers account, or by wireless signal sent to the machine, for example from a cell phone or other device carried by the consumer. In any case, it is most preferred that the containers be positioned adjacent to the fresh food that would be placed in the containers and/or in a position in which a customer would have a line-of-sight to the containers while shopping for the fresh food as a reminder of the availability and benefit of using the containers. In one embodiment, the bags may be prefilled with produce, so the consumer simply check out the produce already packaged in an appropriate freshness bag, while paying for a single freshness bag.

Containers that can be used in the method of the invention may be made of any material suitable for the carrying and storage of the fresh food with which they will be used. Plastic and paper will be the most common examples. The containers may take the form of a bag (structured or unstructured) or a harder plastic container, similar to those sold under the Tupperware® or Gladware® brands.

An important aspect of the invention is the opportunity for the store to sell, and for the consumer to buy, the container individually for immediate use in the store and pay for it separately from the food in the container. This can be accomplished many ways. In one form of the method of the invention, the store will charge the customer for the container on a “per container” basis at the time of checkout, along with the food. Another approach would be to permit the customer to purchase the container while shopping, for example in the produce section of the store, from a kiosk or machine. In either case, the method of the invention differs from the current method for purchasing fresh food in the thin plastic bags commonly given away by grocers. In this current and prior method the food and bag are weighed together at the time of checkout and the customer may pay some amount, although it may be very small, by weight of the bag along with the food. In the method according to the invention, however, the customer pays for the container not by weight, but on a price-per-container basis. The advantage is that the consumer can purchase only so many containers as are needed at a particular time, and at the same time, place the fresh food in the container in the store. There is then no need to replace the food in a different container when the food is taken home, simplifying storage and maximizing the chances that the fresh food will be stored properly to insure freshness. The food will then stay fresher longer and the consumer will benefit from avoiding spoilage before the food was to be consumed. The amount charged will reflect this benefit. For the grocer the advantage is the revenue stream generated by the consumer's purchase of the container.

What is claimed is:

1. A method for selling an individual storage container, the method comprising the steps of:
(1) providing to a store customer a fresh food item sold in bulk, the fresh food item selected from the group consisting of fruit, vegetables, and combinations thereof;
(2) providing to a store customer an empty, individual storage container from a packet of empty, individual storage containers, the packet not being suitable for individual sale and the individual storage container being suitable for individual sale, the individual storage container including a characteristic that permits food stored in the container to remain fresh longer than if the food item is not stored in the container, the individual storage container having both a description of a suitable fresh food item and a universal product code marking;
(3) permitting the customer to place the desired amount of fresh food item inside the empty, individual storage container to obtain a desired amount of fresh food item packaged in the storage container for freshness; and
(4) permitting the customer to purchase in one transaction the combination of the desired amount of fresh food item and the individual storage container, the individual container purchased on a per unit basis and the fresh food item purchase on a per weight basis, the transaction not requiring the removal of the fresh food item from the individual storage container.

2. The method of claim 1 wherein the storage container comprises a plastic bag including an integrated closure.

3. The method of claim 2 wherein the integrated closure is a zipper.

4. The method of claim 1 further comprising the step of displaying the food storage container in a produce section of a store.

5. The method of claim 1 further comprising the step of permitting the customer to purchase the individual container at a point of its display.

6. The method of claim 1 wherein the container is substantially transparent.

7. The method of claim 1 wherein the characteristic that permits food stored in the container to remain fresh longer than if the food item is not stored in the container is selected from the group consisting of a controlled gas permeability film material, an odor control agent, a desiccant or other moisture absorbing component, and a means for limiting or eliminating contact between pieces of the food in the container or contact between the food in the container and surfaces outside the container.

8. The method of claim 1 wherein the container includes a controlled gas permeability film material.

9. A method for selling an individual storage container, the method comprising the steps of:
(1) providing to a store customer a fresh food item sold in bulk, the fresh food item selected from the group consisting of fruit, vegetables, and combinations thereof, the fresh food item having a first universal product code marking;
(2) providing to a store customer an empty, individual storage container from a packet of empty, individual storage containers to a store customer, the packet not being suitable for individual sale and the individual storage container being suitable for individual sale, the individual storage container including a characteristic that permits food stored in the container to remain fresh longer than if the food item is not stored in the container, the individual storage container having both a description of suitable fresh food items and a second universal product code marking;
(3) permitting the customer to place the desired amount of fresh food item inside the empty, individual storage container to obtain a desired amount of fresh food item packaged in the storage container for freshness; and
(4) permitting the customer to purchase in one transaction the combination of the desired amount of fresh food item and the individual storage container, the individual container purchased on a per unit basis and the fresh food item purchase on a per weight basis, the transaction allowing reading of both the first universal product code marking and the second universal product code marking, the transaction not requiring the removal of the fresh food item from the individual storage container.

10. The method of claim 9 wherein the storage container includes a component that acts as a desiccant.

11. The method of claim 9 wherein the storage container includes a component that acts as a moisture or odor absorbent.

12. The method of claim 9 further comprising the steps of reading the first and second universal product codes at the time of purchase to determine the price to be charged for the container and fresh food item.

13. A method for selling a wholly flexible individual storage bag, the method comprising the steps of:
(1) providing to a store customer a food item sold in bulk, the food item selected from the group consisting of fruit, vegetables, cheeses, meats and combinations thereof;
(2) providing to a store customer an empty, individual wholly flexible storage bag having an integrated closure, the individual wholly flexible storage bag contained within a packet of multiple empty, wholly flexible individual storage bags, the packet not being suitable for individual sale and the individual wholly flexible storage bag being suitable for individual sale, the individual wholly flexible storage bag including a characteristic that permits food items stored in the bag to remain fresh longer than if the food item is not stored in the storage bag, the individual wholly flexible storage bag having both a description of a suitable food item and a universal product code marking;
(3) permitting the customer to place the desired amount of food item inside the empty, wholly flexible individual storage bag to obtain a desired amount of food item packaged for freshness; and
(4) permitting the customer to purchase in one transaction the combination of the desired amount of food item and the wholly flexible individual storage bag, the wholly flexible individual storage bag purchased on a per unit basis and the food item purchase on a per weight basis, the transaction not requiring the removal of the food item from the wholly flexible individual storage container.

14. The method according to claim 13, further comprising the step of visually depicting by way of a display adjacent to the food item the storage benefit of using the wholly flexible bag for storing the food item as opposed to storing the food item without the benefit of the wholly flexible bag.
